(19) United States
(12) Patent Application Publication
(10) Pub. No.: US 2005/0034440 A1
(43) Pub. Date: Feb. 17, 2005

(54) Turf bumper for turf grass mowing equipment

(76) Inventors: Todd Alan Canterbury, Lafayette, IN (US); Ana Maria Rus Alvarez-Canterbury, Lafayette, IN (US)

Correspondence Address: Todd A. Canterbury, Apt. 417, 3162 Pheasant Run, Lafayette, IN, 47909, US

(21) Appl. No.: 10/916,293

(22) Filed: Aug. 11, 2004

Related U.S. Application Data
(60) Provisional application No. 60/494,319, filed on Aug. 11, 2003.

(51) Int. Cl. A01D 67/00

(52) U.S. Cl. 56/320.1

(57) ABSTRACT

A device supported by a turf grass or agricultural mowing machine to provide for the reduced energy created from accidental contact between a object and said machine, while increasing the time the operator has to adjust the direction and speed of the machine. This contact routinely occurs during the maneuvering of the machine under normal operating speeds and conditions. The Turf Bumper accomplishes this by system that directs collision or contact energy to a system of energy absorbing devices. The initial contact with an object can occur with the wheel (100) followed by succeeding contact with a series of rollers (301, 302) that are attached connected to individual acting force vectoring devices (400). The force vectoring devices direct the energy generated from contact with an object to the energy absorbing devices (500). As the machine continues moving, the next adjacent roller contacts the object and causes its force vectoring device (400) to move or rotate a limited amount within the upper and lower supports (700, 800) while contacting the energy absorbing devices in a parallel effort.

### FEDERALLY SPONSORED RESEARCH

Not Applicable

### SEQUENCE LISTING OR PROGRAM

Not Applicable

### BACKGROUND

1. Field of Invention

This invention relates to a device for turf grass mowing and agricultural mowing equipment, specifically to provide a means to reduce damage during accidental or intended contact with an object during close maneuvering that allows continued movement in either a forward or reverse direction.

2. Description of Prior Art

This invention relates to turf grass and agricultural mowing equipment. A lawn mower is a general term that describes a device used to trim the height of crops or turf grass. A lawn mower takes various forms when used to mow turf grass and crops on farms, golf courses, municipal streets, highways, public areas, parks, recreation areas, commercial and residential properties, cemeteries and orchards. A user of lawn mowing equipment specifically intends to maintain the height of turf grass or crops. This activity is referred to as turf grass maintenance, or more commonly mowing. Mowing is a maintenance activity which provide a healthy and usable turf grass surface for a range of human and animal activities. These range from esthetic pleasure to livestock feed cultivation, golfing or football. A turf grass or agricultural grass area is the end result of a land development process. This area sometimes has objects (man made or natural) within it like trees, shrubs, boulders, fences or sign posts. Although the equipment used to maintain the height of turf grass is highly maneuverable, some difficulty occurs when the operator attempts to maneuver the equipment in and around or very close to these objects. The desire to mow as close as possible to objects is a direct effort to reduce the amount of grass that must be later manually trimmed. Trimming of this turf grass is normally done by using a device commonly referred to as a gasoline powered trimmer, weed whacker or string trimmer.

The main component that cuts or trims the grass during the mowing activity has four basic designs. These designs are commonly referred to as a Deck Mower, a Reel Type Mower, A Sickle or Bar Mower and A Flail Mower. The Deck Mower, consists of a common housing that contains one or multiple powered blade(s) that rotate in a circular motion parallel to the ground. The rotation of the blade(s) cut the turf grass to the desired height as the deck travels over the ground at a specified speed and height. The second design is commonly referred to as a Reel Type mower. The design utilizes a series of uniformly spaced blades that rotate around a common horizontal shaft (a reel) next to a second stationary blade. The clearance between the rotating reel mounted blades and the fixed blade is small (hundredths of an inch). The reel is connected through a set of mechanical gears in a ratio greater than 1:1 to a set of wheels. As these wheels roll over the ground, they transmit the rolling action to the reels. The turf grass is cut when it moves between the spinning blades on the reel and the fixed blade. This action is similar to that of scissors. The third design is commonly referred to as a sickle mower. The design contains two basic components. A fixed blade with multiple guides that protrude in the direction of travel several inches and a second powered blade with a serrated edge. The powered blade moves linearly in a back and forth motion just behind the fixed blade with the protruding guides. The turf grass or crop is mowed when it moves between the protruding guides and the serrated blade. The fourth design is commonly referred to as Flail Mower. Its design consists of a metal tube of various length that rotates at high speed. Attached in a linear fashion along the length of the tube is a series of small metal squares or rectangles called a flail heads. Each flail head is attached by a metal chain link or a wire cable to the rotating tube. The drum has multiple rows of these around its circumference. The spinning of the tube generates centrifugal forces that act on the flail heads. The turf grass is cut as the spinning tube and flails are passed over the turf grass or crop at a the desired height.

Anytime any part of these turf mowing machines come into contact with an object like a tree, sign post, concrete culvert or large diameter rock/boulder, damage to both the object and the machine can occur. Each mower and agricultural implement mower design has within it a section, part or distinct area, that allows the operator to maneuver very close to objects in order to minimize the amount of turf grass that must be manually trimmed. This area, section or part of the turf mower is commonly called the trim edge. Due to difficulty in maneuvering from a variety of factors (uneven surfaces, speed, mechanical wear, mis-adjustment or operator error), the trim edge comes into contact with the object. When this occurs at relatively low speeds, the objects and the turf mower receive only cosmetic damage. Damage commonly called scratches, marks or marring. Higher speeds result in structural damage to the object and the turf mower and in the worst cases, injury to the operator. The turf mowing machine, its operator and the objects are expensive to repair or replace.

Thereafter, inventors created several types of bumpers and energy management suspensions for vehicles and various turf grass mowing maintenance equipment. U.S. Pat. No. 3,965,657 to Jespersen (1974) discloses a rear safety bumper for rider mowers. The patent is a movable bar commonly called a bumper. It attaches to a lawn mower frame rearwardly and is designed to disengage the transmission of power to the rotating blade(s) located in the mower deck. This bumper design neither reduces the energy created, or the resulting effects from an accidental, intended or temporary contact between the machine and an object. The design also does not contain rollers that allow the machine to ride against the uneven vertical surface of a tree, sign post, boulder, retaining wall, mail box post, concrete culvert or other object. The device also does not contain any energy vectoring devices or any devices to absorb the energy generated during contact.

U.S. Pat. No. 2,729,299 to Rink (1956) discloses a vehicle power transmission and control for a powered vehicle. This patent does contain a bumper device connected to an energy absorbing device that transmits energy resulting from contact with an object to a mechanical lever system that disengages power to a vehicles drive wheels. This device by itself, when attached to a vehicles front bumper, only minimally reduces the energy transmitted to the vehicle during contact with and object. The device also uses a mechanical lever system design to disengage the power transmitted to the drive wheels. This is only designed to prevent continued forward movement of a vehicle after frontal contact with an object in its path.

U.S. Pat. No. 6,142,542 to Sherno (2000) discloses a collision impact absorber. This invention contains a means to absorb and transmit the energy generated during contact with an object. The vectoring device is able to slide and rotate about a horizontal axis. The invention attaches between the frame and an external surface of a motor vehicle. This invention transmits the kinetic energy from a collision through a mechanical lever system that vertically lifts the vehicle. The collision forces are dissipated or offset by the vehicles weight during the vertical movement. The design and function of this invention is of no use on turf grass mowers. The speeds are significantly lower and on occasion intended contact with an object occurs. The invention also fails to provide a low friction surface or system like rollers or wheels that rotate about any axis between the vehicle and the object. This failure to provide a low friction surface or system of rollers or wheels can also be seen in the following U.S. Pat. No. 1,360,369 to Cohen (1920) a Auto-Bumper; U.S. Pat. No. 5,823,587 to Kim (1998) a bumper system for vehicles having bumper supporters and U.S. Pat. No. 6,554,332 to Schuster et al (2003) pedestrian impact energy management device with seesaw elements.

### SUMMARY

A device that provides for a means to reduce the damaging effects of energy that are generated when contact occurs between an object and a turf grass or agricultural mowing maintenance equipment during normal operation and speeds, that further allows the machine to maintain forward or reverse movement during extended contact with the object.

### OBJECTS AND ADVANTAGES

Accordingly, besides the objects and advantages of the Turf Bumper described in my above patent application, several objects and advantages of the present invention are:
(a) to provide a bumper systems with components that attach to and are supported by a turf grass or agricultural mowing equipment, being convenient and extremely rapid and economical to manufacture;
(b) to provide a bumper to reduce the likelihood of damage to objects or the turf grass or agricultural mowing equipment during intentional and purposeful close maneuvering with objects in or near its intended path;
(c) to provide a bumper that allows the continued transmission of power to the driving wheels of the turf grass or agricultural mowing equipment during and after contact with an object;
(d) to provide a system that reduces the amount of energy transmitted to the operator;
(e) to provide a system that increases the reaction time to the operator so that speed and direction can be corrected during intended, temporary or continuous contact with an object;
(f) to provide a bumper that reduces structural or cosmetic damage to the turf grass or agricultural mowing equipment or the object in its maneuvering area.

### DRAWINGS

### Drawing Descriptions

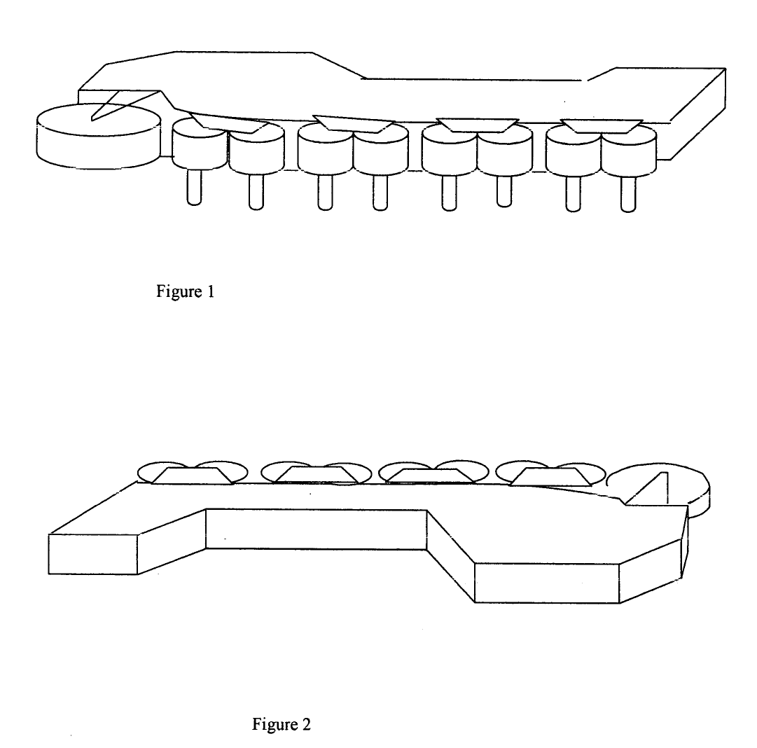

FIG. 1 is a perspective right-side view of the Turf Bumper in accordance with the invention, showing the upper and lower outrigger rollers.

FIG. 2 is a perspective left-side view of the Turf Bumper of FIG. 1.

FIG. 3 is a lateral cross-section view of the Turf Bumper of FIGS. 1 and 2

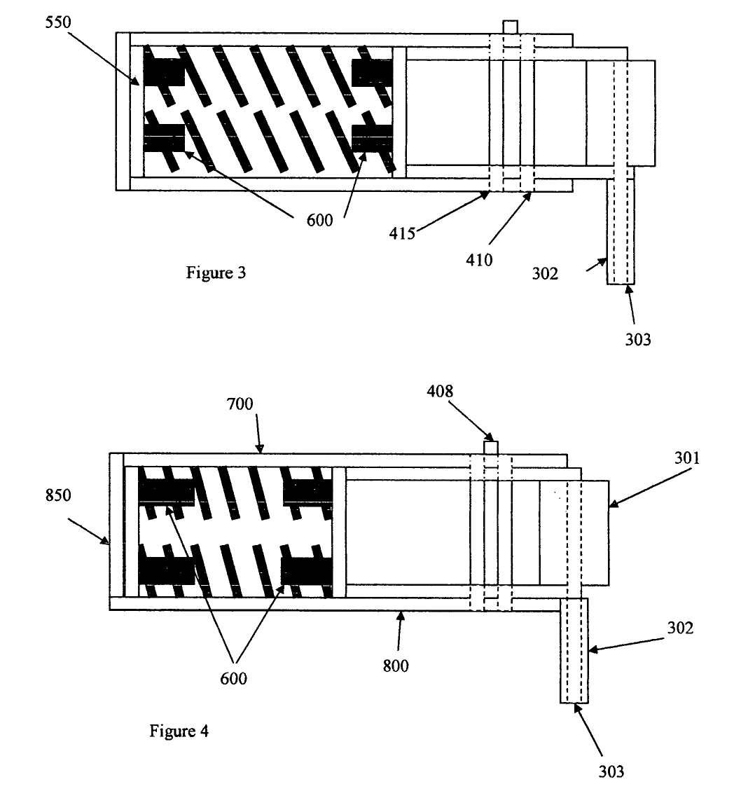

FIG. 4 is a lateral cross-section view of the Turf Bumper of FIGS. 1 and 2 with the outrigger rollers and springs in a position that indicates contact with an object.

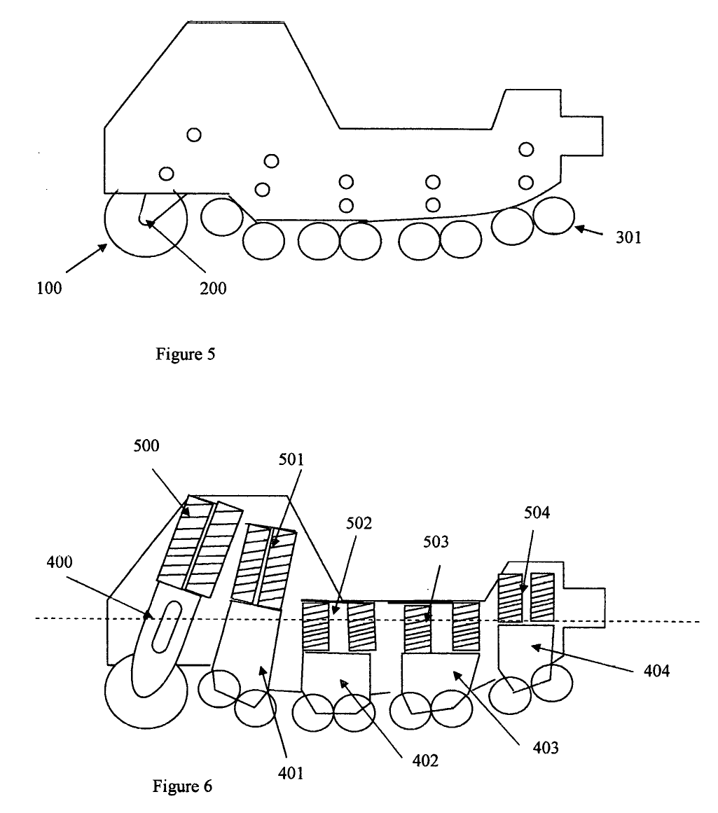

FIG. 5 is a view of the Turf Bumper from above.

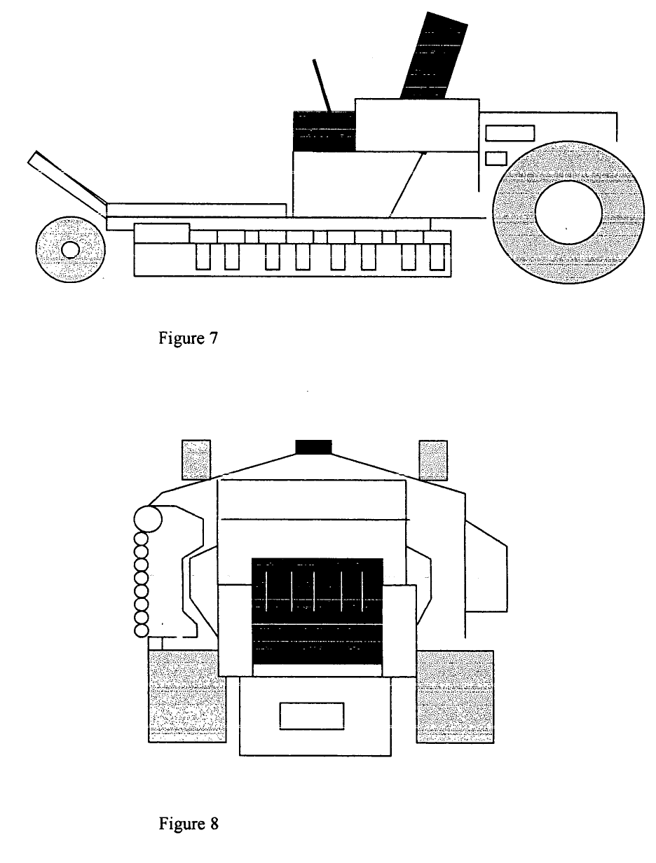

FIG. 6 is a top view of the Turf Bumper with the upper support removed, showing the principle internal parts and their orientation.

FIG. 7 is a side view of the Turf Bumper showing the position as it would be installed on a common commercial riding turf lawn mower.

FIG. 8 is a top view of the Turf Bumper showing the invention as it would be installed on a common commercial riding turf lawn mower.

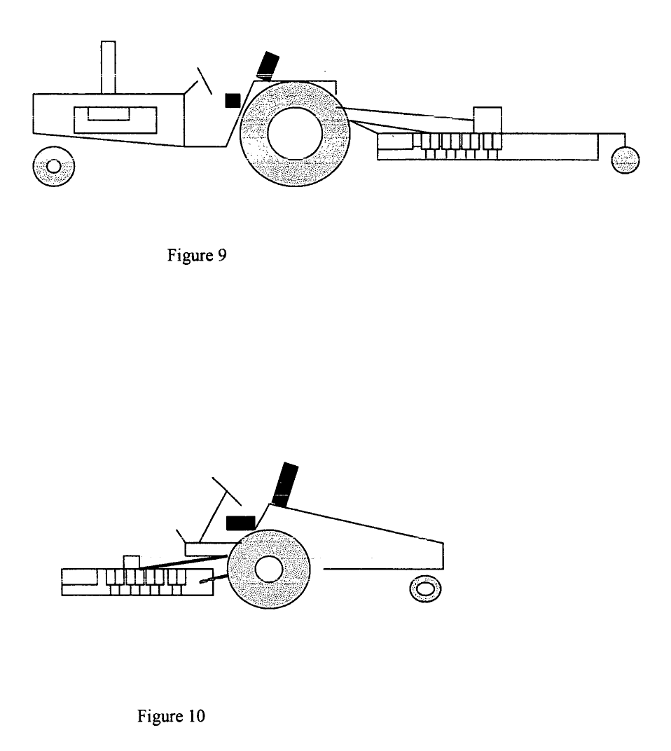

FIG. 9 is a side view of the Turf Bumper showing the invention as it would be installed on a common agricultural mowing implement, as a additional embodiment.

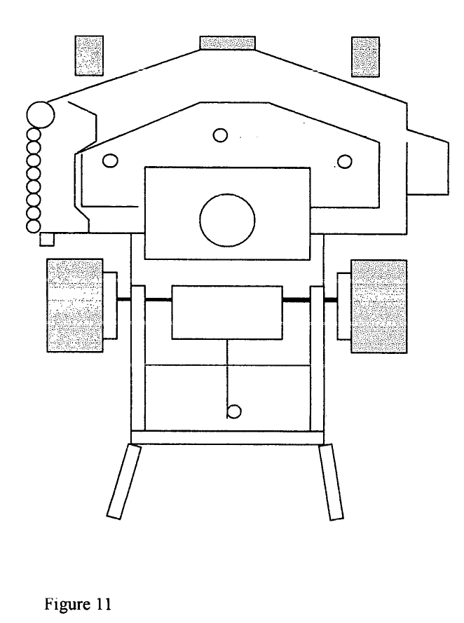

FIG. 10 is a side view of the Turf Bumper showing the invention as it would be installed on a second style of common commercial riding lawn mower, as a additional embodiment

FIG. 11 is a top view of the Turf Bumper showing the invention as it would be installed on a common commercial walk behind lawn mower, as a additional embodiment.

### Reference Numerals in Drawings

100 wheel 500 set 1; coil or wave spring, or gas shock system
200 wheel axle 501 set 2; coil or wave spring, or gas shock system
301 upper outrigger roller 502 set 3; coil or wave spring, or gas shock system
302 lower outrigger roller 503 set 4; coil or wave spring, or gas shock system
303 outrigger roller support 504 set 5; coil or wave spring, or gas shock system
400 outrigger box 1 550 backer plate
401 outrigger box 2 600 spring keepers
403 outrigger box 3 700 upper support
404 outrigger box 4 800 lower support
408 pivot pin grease fitting 850 stiffener plates
410 forward pivot bolt 900-905 backer plates
415 aft pivot bolt

### DETAILED DESCRIPTION

### Description—FIGS. 1 and 2—Preferred Embodiment

The preferred embodiment of the Turf Bumper is illustrated in FIG. 1, a perspective view taken from the user's left side of the Turf Bumper, constructed in accordance with the invention. The invention has a design consisting of a multiple energy absorbing devices connected to an energy vectoring device 400-404. These are connected to a wheel 100 and rollers 301-302. The invention has an upper 700 and a lower 800 support, which allows the Turf Bumper to be adapted, or modified to fit a variety of turf grass or agricultural mowing maintenance equipment designs.

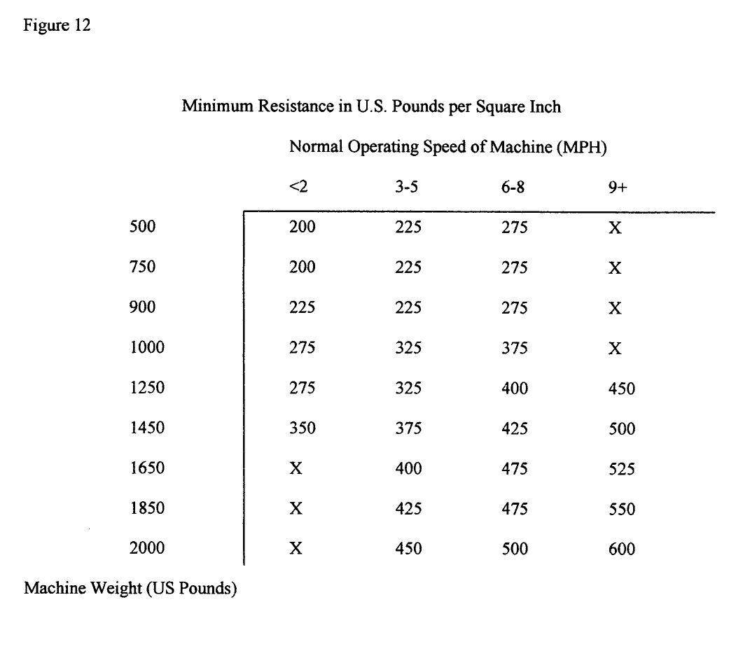

In FIGS. 3 and 4 the upper and lower supports allow for the attachment of multiple stiffener plates 580 and backer plates 550. The backer plates in FIGS. 3 and 4 also support one side of the spring keepers 600. FIG. 5 also shows each backer plate being oriented between 45 degrees and 0 degrees to an imaginary reference line running the length of the invention. Attached to each backer plate are two sets of horizontal oriented energy absorbing devices 500-504. Shown in the preferred embodiments are coil springs. These springs are positioned in a parallel arrangement in FIGS. 3 and 4. The energy absorbing devices shown here are coil springs, their actual specifications of free height, working load, number of coils and the amount of pounds to compress, will change in response to the weight and normal operating speeds of a particular mowers design. FIG. 12 shows a table that indicates a minimum resistance in U.S. Pounds for a range of mower weights versus their operating speeds. The physical size and characteristics of the energy absorbing device will differ between that used on a 36″ commercial walk behind lawn mower and those used on a ten foot agricultural bush hog or flail mower. The energy absorbing devices remain in place by a set of spring keepers and are supported by the outriggers boxes 400-404 and the backer plates 550 (FIG. 3).

The first supported rollers in FIG. 1 is a larger diameter than the succeeding rollers. It is referred to as 100 in FIG. 5. The remaining outrigger rollers are various diameters and attached to the outrigger boxes 400-404 by a pin 303 running through their centers in FIGS. 3 and 4. Each of the outrigger box's 400-404 have a slot in its top and bottom. The diameter and length of this slot changes with the weight and normal operating speed of the lawn mower. Both the forward 410 and aft pivot pin 415 passes through the upper and lower slot of each outrigger box and is supported by the upper 700 and lower 800 supports. This allows the outrigger boxes to rotate in a narrow range of angles while remaining free to slide between the upper and lower supports.

Attached to the upper support 700 and located between each pivot pin is a single pivot pin grease fitting 303, as seen in FIG. 3. The outriggers supports are fastened to the outrigger boxes 400-404. The outrigger pin 303 supports one upper 301 and one lower outrigger 302 roller. Each outrigger roller remains free to rotate with little resistance in either direction.

### FIGS. 9-11—Additional Embodiments

Additional Embodiments are shown in FIGS. 9, 10 and 11. In each of these cases, the Turf Bumper is shown attached to a common mowing system. FIG. 11 indicates the Turf Bumper as it would be supported by a common commercial walk behind turf grass mower. In FIG. 9 the Turf Bumper is shown in and additional embodiment. Supported by a agricultural mowing implement commonly referred as a brush cutter, or bush hog. The size and diameter of the energy absorbing devices and rollers have been altered in response to this machines weight and operating speeds. In FIG. 10 the Turf Bumper is shown in an additional embodiment and supported by a second style or alternative design of commercial riding turf grass mower commonly referred to as a front deck mower or out front mower. In FIGS. 9, 10 and 11 the size and diameter of the energy absorbing springs, the force vectoring outrigger box, the pivot pins and the outrigger supports have all been altered in response to the machines weight and operating speeds.

### Operation—FIGS. 3, 4, 5, 6

The Turf Bumper is used during the normal operation of turf grass mowing. The Turf Bumper can be added by the manufacturer during assembly, as a component of the turf grass mower, or added at a later date by the consumer. By either method, the Turf Bumper enables the operator to maneuver the turf grass mowing machine closer to an object. The Turf Bumper operates when the mower is operating in a normal forward (or backward) operation. As the leading outrigger roller (FIGS. 1 and 2) contacts an object, the energy is transferred by the outrigger rollers 100, 301 or 302 and outrigger supports 303 to the outrigger boxes 400-404. The outrigger box is able to rotate about the forward 410 and aft pivot bolt 415 in response to the force generated during contact with the object. The amount of rotation is small, 5-10 degrees. The force resulting from contact is transmitted by the outrigger box 400-404 to the energy absorbing devices 500-504. These are shown as coil springs in FIGS. 3, 4 and 5. This small amount of rotation of the outrigger box causes the lagging outrigger roller 301 to move in the opposite direction of the leading roller (FIG. 3).

This movement between the leading and lagging outrigger rollers can be described as a seesaw effect between the two parallel mounted outrigger wheels. This occurs in both a forward (or reverse) movement of the turf grass mower. As the rotation about the pivot bolts reaches its limits, the force then begins to collapse the energy absorbing devices 500-504. This is allowed due to the slot in the outrigger box top and bottom. This slot allows the outrigger box to rotate and slide about the pivot bolts. The two sets of parallel springs results in a significant resistance to the force generated from contact with and object. As the mower continues forward, each outrigger roller remains free to rotate about the outrigger roller support. This allows the object to be rolled to the next succeeding outrigger roller with little friction. Because of the rolling effect, damage from friction is minimized. The object simply rolls along the series of outrigger rollers with little damage.

This result's in three benefits:
(1) Increased confidence by the operator that any accidental and temporary contact with and object will not result in no, or little structural or cosmetic damage to the object or the turf grass mowing machine.
(2) Provides increased reaction time to the operator so that the speed and direction of the turf grass mower can be changed before said damage occurs.
(3) Allows for the reduced frequency and quantity of said energy from said contact being transmitted by said machine to the operator, resulting in reduced cognitive and physical fatigue to the operator.

The quantity of outrigger rollers, roller supports, outrigger boxes, energy absorbing system and its overall resistance, and the diameters of pins and bolts will (in reference to each design) be a result of the weight and operating speeds of the turf grass mower. The weight and the operating speeds among the different types, styles and designs of turf grass and agriculture mowing machines is considered when the Turf Bumper is applied to each.

1. A device that provides for a means to reduce the damaging effects of energy that are generated when contact occurs between an object and a turf grass or agricultural mowing maintenance equipment during normal operation and speeds and allows the said machine to maintain movement during contact with the object.

2. The device in claim 1 contains multiple components arranged in a system that absorbs said energy from said contact when transmitted to the said machine increasing the operators reaction time such that the speed and direction of the said machine can be changed before said damage occurs further allowing for the reduced etfects of said energy from said contact to be transmitted by said machine.

3. The device in claim 1, reduces the said energy transmitted to the said operator resulting in reduced cognitive and physical fatigue to the said operator.

4. The said components in claim 2, wherein are supported by said machine and contained within a housing that is further supported and located in a area on said machine that allows for close maneuvering around objects generally referred to as the trim side.

5. The said machine is intended to maintain organic plants at a specific height is powered and requires a human operator to maneuver said machine in and around or within close proximity of naturally occurring or man made objects, during the normal speeds of said equipment.

6. The force absorbing devices in claim 2 can be of the design of coil spring, leaf spring, gas charged shock, wave or torsion spring style and can vary in dimension and consistency depending on the weight and operating speed of the machine; the device and its components are constructed of metal, where low friction devices are wheels and rollers that contact the said objects can be selected from the group consisting of man made synthetics or polymers with varying performance characteristics and consistencies.

7. The low friction devices in claim 6 are vertically positioned and protrude from the housing in claim 4 and make first contact with an object and are free to spin about a vertical axis and are supported by a member that runs through its center.

8. The support member in claim 6 is connected to a energy vectoring device that allows the transmission of said energy in claim 1 and is located inside and supported by the housing in claim 4.

9. The housing in claim 4 allows the energy vectoring devices in claim 7 to move freely and rotate about an axis freely.

10. The movement in claim 9 is allowed by two corresponding slots placed in the energy vectoring device.

11. The corresponding slots in claim 10 have two shafts or pins passing through them and is supported by the housing in claim 4.

12. The energy vectoring device being free to move and rotate a maximum amount, due to the shafts in claim 11, can thus transfer the said energy in claim 1 to a set of energy absorbing devices in claim 2 taking any of the following designs, coil, leaf, wave, gas charged or torsion.

13. The energy absorbing devices in claim 2 are supported by the housing in claim 4 that is connected to and supported by said machine in claim 1.

14. The energy absorbing devices in claim 13 are positioned such that the force vectoring device in claim 8 begins to transfer any amount of force when the machine in claim 1 contacts an object in its path.

15. As the machine in claim 1 continues in a forward or reverse direction while in contact with said object the next adjacent low friction device in claim 6 then proceeds to make contact while being supported by said machine in claim 1.

16. Whereby, (a) during the said activity, the said application of the said device is novel, unique and unobvious in its application to the turf grass or agricultural organic grass mowing maintenance equipment, (b) where the area, part of section of the said machine is used to maneuver closely in and around objects in claim 4, will (c) reduce both the period, frequency and amount of energy applied to both said machine and said objects and said operator.
